(19) United States
(12) Patent Application Publication
(10) Pub. No.: US 2010/0276336 A1
(43) Pub. Date: Nov. 4, 2010

(54) REACTOR AND PROCESS FOR ENDOTHERMIC GAS PHASE REACTIONS

(75) Inventors: Gilles Ferschneider, Chaponnay (FR); Beatrice Fischer, Lyon (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: IFP

(21) Appl. No.: 12/746,296

(22) PCT Filed: Dec. 1, 2008
(86) PCT No.: PCT/FR08/01673

§ 371 Date: Jun. 4, 2010

(30) Foreign Application Priority Data
Dec. 6, 2007 (FR) 0708561

(51) Int. Cl. C10G 65/02; B01J 8/04

(52) U.S. Cl. 208/49; 422/190

(57) ABSTRACT

The invention concerns a reactor for carrying out an endothermic gas phase reaction having a cylindrical shape along a vertical axis and comprising at least four annular zones, centred on the vertical axis and in succession from the edge towards the centre of the reactor, namely a first zone 201 termed the supply zone, a second zone 202 termed the catalytic zone, a third zone 203 termed the collection zone and a fourth zone 204 termed the exchange zone. The reactor also comprises vertical hermetic panels 65 located along the radii of the cylindrical reactor which divide the reactor into sectors, said sectors each comprising at least one exchange section 61 and at least one catalytic section 62. The two first exchange sections are connected and a conduit 64 connects the collection section of each sector, with the exception of the first and last sector, to the exchange section of the next sector.

The invention also concerns the process employing the reactor of the invention.

### FIELD OF THE INVENTION

The invention relates to a reactor and a process employing said reactor for endothermic gas phase reactions over a solid catalyst. Said reactor is particularly suitable for catalytic reforming and for hydrocarbon dehydrogenation reactions.

The present invention relates to a reactor which can recover heat from pressurized combustion gas and use it for reactions.

The process uses a combustion gas under pressure to heat the reactor by indirect heat exchange inside the reactor.

### PRIOR ART

Heavy gasoline cuts (80-180° C.) principally comprising C₆ to C₁₀ hydrocarbons deriving from the initial distillation of oil is normally processed to bring their octane number to a high value for use in an automotive vehicle engine. The catalytic reforming process can carry out that operation. That process consists of passing the gasoline cut, in the presence of hydrogen, over a catalyst including precious metals at a high temperature (Close to 500° C.). The catalytic reforming reactions principally consist of dehydrogenating naphthenes and paraffins present in the feed to transform them into aromatics which have a high octane number and to isomerize the remaining paraffins to additionally increase the octane number of the gasoline. A first unwanted reaction is cracking, which produces light hydrocarbons such as methane, ethane, propane and butane and which reduces the yield of the operation. A second unwanted reaction is coking of the catalyst, which reduces the activity of the catalyst and obliges its periodic regeneration by burning the coke to re-establish its activity. Cracking is greater with increased pressure. Thus, the yields are better at low pressure. However, coking is higher with a lower partial pressure of hydrogen.

Old units operated at high pressure (approximately 15 to 30 bars), with a high hydrogen recycle ratio, giving mediocre yields and could operate for approximately 11 months before the catalyst had to be regenerated.

Continuous catalyst regeneration units can regenerate all of the catalyst in a few days, to allow low pressure operation (approximately 3 to 5 bars), and thus increase the yields. The catalyst moves continuously in the reactors, which are thus radial in type, and is sent to a regeneration section in order to be regenerated, before being returned to the first reactor. Dehydrogenation reactions are highly endothermic and the reactions stop when the temperature is too low. Current processes generally comprise three or four reactors and as many furnaces in series. Each furnace is followed by a reactor. Because of the high temperatures, the furnace yields are low and it is normal to produce steam to improve the overall yield of the furnace. It is also normal to use that steam to actuate a turbine which drives the recycle compressor and the hydrogen exportation compressor. Recently, it has become more usual to use a variable speed electric motor for the compressors and less steam is used in modern refineries which for economic reasons tend to prefer using electricity. For that reason, the use of large size furnaces which generate steam with the associated operation and maintenance problems is now considered to be a drawback of the process.

Other hydrocarbon dehydrogenation processes such as long chain paraffin dehydrogenation use a process which is identical to catalytic reforming and suffer from the same problems.

### BRIEF DESCRIPTION OF THE INVENTION

The invention concerns a reactor for carrying out an endothermic gas phase reaction having a cylindrical shape along a vertical axis and comprising:
at least four annular zones, centred on the vertical axis and in succession from the edge towards the centre of the reactor, namely a first zone 201 termed the supply zone, a second zone 202 termed the catalytic zone, a third zone 203 termed the collection zone and a fourth zone 204 termed the exchange zone;
vertical hermetic panels 65 located along the radii of the cylindrical reactor which divide the reactor into sectors, said sectors each comprising at least one exchange section 61 and at least one catalytic section 62, the ensemble of said exchange sections forming the exchange zone 204 and the ensemble of said catalytic sections forming the catalytic zone 202;
and in which the two first exchange sections are connected and in which a conduit 64 connects the collection section of each sector, with the exception of the first and last sector, to the exchange section of the next sector.

The invention also concerns the process using the reactor of the invention.

In order to heat the reactor, preferably a reforming reactor, the present invention generally uses pressurized combustion gases which means that electricity can be produced for the catalytic reforming unit, and possibly for other units. A single reactor is generally used, with special internal means which mean that the sections for heating by exchange with the combustion gas can be alternated with the adiabatic catalytic sections, with the catalyst being able to move in the reactor under gravity. The overall footprint of the unit, the amount of equipment and the cost of the reaction section are thus reduced.

If the reactor dimensions are too large, then in the case of very large capacities, several reactors of this type may be present, preferably in parallel. Each reactor is then generally supplied by a dedicated air compressor and a dedicated burner.

### DETAILED DESCRIPTION OF THE INVENTION

Throughout the text, 1 bar is equivalent to 0.1 MPa.

The invention concerns a reactor for carrying out an endothermic gas phase reaction having a cylindrical shape along a vertical axis and comprising:
at least four annular zones, centred on the vertical axis and in succession from the edge towards the centre of the reactor, namely a first zone 201 termed the supply zone, a second zone 202 termed the catalytic zone, a third zone 203 termed the collection zone and a fourth zone 204 termed the exchange zone;
vertical hermetic panels 65 located along the radii of the cylindrical reactor which divide the reactor into sectors, said sectors each comprising at least one exchange section 61 and at least one catalytic section 62, the ensemble of said exchange sections forming the exchange zone 204 and the ensemble of said catalytic sections forming the catalytic zone 202;
and in which the two first exchange sections are connected and in which a conduit 64 connects the collection section of each sector, with the exception of the first and last sector, to the exchange section of the next sector.

Within the context of the invention, the first sector is defined as the sector in which the reactor is supplied with reaction mixture. The other sectors are termed the second sector, third sector up to the last sector, following the order in which the reaction mixture moves in the reactor. As an example, in the case of 4 sectors, the first sector is that to which the reaction mixture is supplied to the reactor. The reaction mixture then moves in succession in said first sector then in the second sector, then in the third sector then in the last sector before being evacuated from the reactor.

In a preferred implementation, the catalytic zone and the exchange zone are in succession from the edge to the centre of the reactor.

In a preferred implementation, the vertical hermetic panels 65 dividing the reactor into sectors are fixed along a central cylindrical zone 205. In general, the sectors each comprise an exchange section 61, a catalytic section 62, a supply section 161 and a collection section 162, the ensemble of said exchange sections forming the exchange zone 204, the ensemble of said catalytic sections forming the catalytic zone 202, the ensemble of said supply sections forming the supply zone 201 and the ensemble of said collection sectors forming the collection zone 203. In general, the reactor comprises an upper head and a lower bottom. At least one pipe 163 per sector generally passes through the upper head of the reactor to supply the catalytic sections with catalyst and at least one pipe 263 per sector passes through the lower bottom of the reactor to evacuate catalyst from the catalytic sections. In general, a supply conduit 17 passing through the upper head of the reactor can supply a sector, denoted the first sector, with reaction mixture, an evacuation conduit 18 passing through the upper head of the reactor can evacuate reaction mixture from the last sector of the reactor. A conduit 67 which connects the collection zone of the last sector to the conduit 18 in order to evacuate the reaction mixture is generally present. In this same variation, an inlet conduit 6 passing through the lower bottom of the reactor is connected to conduits 70 leading to tubular chambers 71. Said tubular chambers distribute combustion gas by means of tubular plates 69 via the bottom of the reactor into each exchange section. Tubular chambers 72 can collect combustion gas from the top of each exchange section, then conduits 73 provided with expansion bellows 74 can evacuate the combustion gas to the outlet conduit 7 which passes through the upper head of the reactor.

Each exchange section is generally constituted by tubular exchangers or plate exchangers. Each exchange section has either an identical surface area, or the exchange surface area increases from the first to the last exchange section.

Each catalytic section is generally formed by two concentric metal screens, preferably of the “Johnson screen” type. All of the catalytic sections generally have the same dimensions or the dimensions of the catalytic sections increase from the first to the last sector.

The vertical hermetic panels 65 generally divide the reactor into 3, 4, 6 or 8 sectors, preferably into 4 or 6 sectors.

The invention also concerns the process for carrying out a catalytic reforming reaction or hydrocarbon dehydrogenation reaction in a reactor in accordance with the invention.

The invention also concerns a process for carrying out an endothermic gas phase catalytic reforming or hydrocarbon dehydrogenation reaction over a solid catalyst in a reactor in accordance with the invention, in which the reaction mixture enters the reactor via the conduit 17 then moves into the supply zone of the first section, passes radially through the catalytic section 62, passing from the supply zone 201 to the collection zone 203 of the reactor. The reaction mixture then moves into the collection section of the first sector before moving from top to bottom in the two connected exchange sections corresponding to the two first sectors, passes under the second catalytic section 62 between the catalyst down pipes 263, then passes radially through the second catalytic section 62, passing from the first zone 201 to the third zone 203 of the reactor, passes to the exchange section of the third sector via the conduit 64. Finally, the reaction mixture moves in succession and in alternating manner in the next exchange sections and the next catalytic sections.

The catalyst generally moves from top to bottom at the same speed in all the catalytic sections. The catalyst can move from top to bottom at a speed which increases from the first to the last catalytic section.

The invention also concerns the process in which the pressurized combustion gas heats the reaction mixture by indirect heat exchange.

In a first variation of combustion gas production, the combustion gas supplying the reactor 60 via the conduit 6 derives from heating air at atmospheric pressure moving via line 1 to an air compressor 2 then via the line 3 towards a combustion chamber 4 in which burning a fuel gas moving via 5 can heat the combustion gas to a temperature in the range 600° C. to 800° C., preferably in the range 650° C. to 750° C.

In a second variation of combustion gas production, the combustion gas supplying the reactor 60 via the conduit 6 derives from heating air at atmospheric pressure moving via the line 1 to an air compressor 2 then via the line 3 towards a combustion chamber 4 in which burning of a fuel gas moving via the line 5 can heat the combustion air which then passes via an expansion turbine 12 which is on the same shaft as the air compressor and which provides the power necessary for compression, the combustion gas leaving the expansion turbine 12 is at a pressure the range 0.2 to 0.45 MPa, and at a temperature in the range 600° C. to 800° C., and preferably in the range 650° C. to 750° C.

In each of the two combustion gas production variations, the combustion gas leaving the reactor via the conduit 7 can be reheated in a combustion chamber 8 before being sent to a turbo-expander 10 to produce electricity.

### BRIEF DESCRIPTION OF THE DRAWINGS

FIGS. 1-4 represent process schemes according to the invention. FIGS. 5-7 represent reactor configurations according to the invention.

### DETAILED DESCRIPTION OF FIGURES

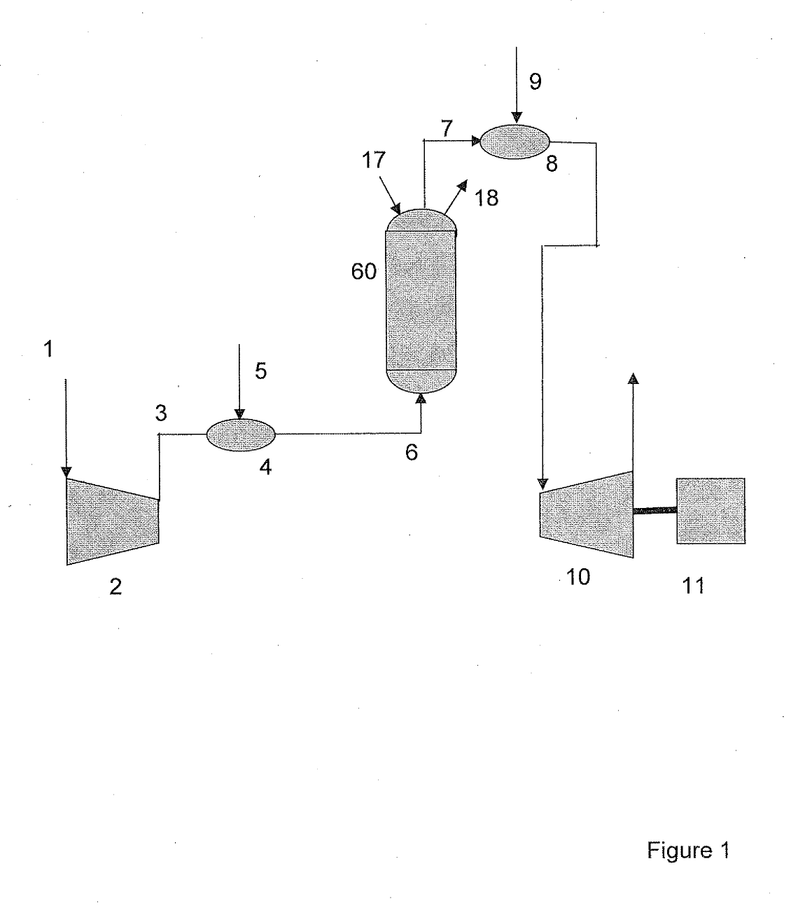

FIG. 1 describes one of the ways of providing heat to the reactor. Atmospheric air is supplied via a line 1 to an air compressor 2. The air is compressed to a pressure close to 4 bars absolute (0.4 MPa) and is then sent via a line 3 to a combustion chamber 4. A fuel gas is supplied via a line 5 for burning in the combustion chamber 4. The depleted air which has been heated by combustion at a temperature of close to 700° C. is sent via a line 6 to the reactor 60.

The reaction mixture enters via a line 17 and leaves via a line 18. The combustion gas cools by exchange with the reaction mixture which is undergoing an endothermic catalytic reforming reaction.

At the reactor outlet, the cooled gas is sent via a line 7 to a second combustion chamber 8 where it is reheated by combustion of fuel gas supplied via a line 9. At the outlet from the combustion chamber, the hot gas is sent at a temperature close to 750° C. to a turbo-expander 10 which drives an alternator 11 to produce electricity.

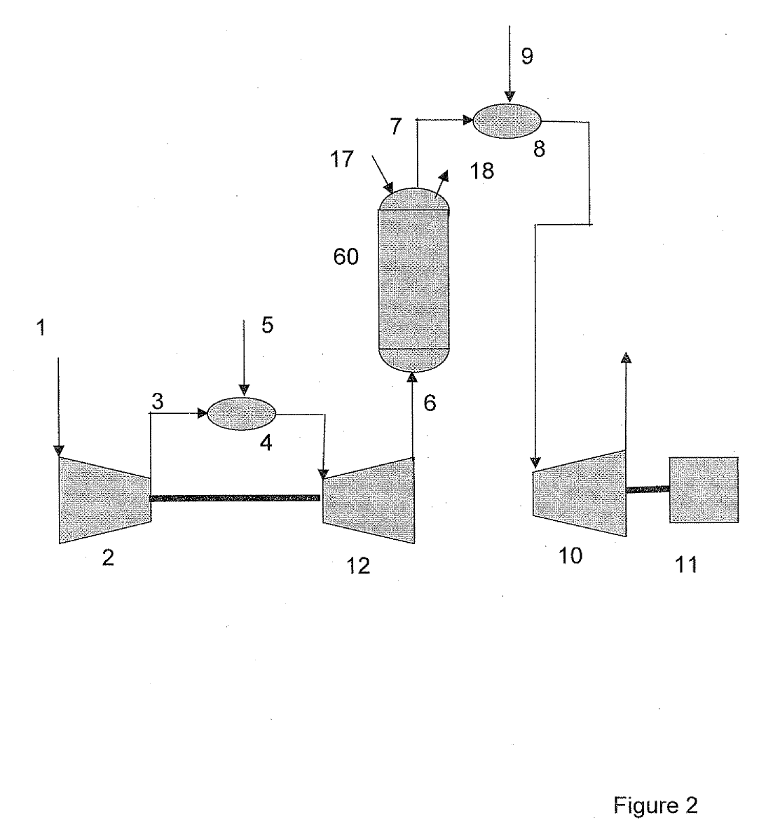

FIG. 2 describes an alternative manner of supplying heat to the reactor 60. Atmospheric air is supplied via line 1 to air compressor 2. Air compressed to a pressure of close to 20 bars is then sent via line 3 to combustion chamber 4. A fuel gas is supplied via line 5 for burning in the combustion chamber 4. The depleted air which has been heated by combustion to a temperature of close to 1300° C. is sent to a turbo-expander 12 which drives the air compressor 2. The gas at the turbine outlet is at about 3 bars and at a temperature of close to 700° C. It is sent via line 6 to reactor 60.

The reaction mixture enters via a line 17 and leaves via a line 18. The combustion gas cools by exchange with the reaction mixture which is undergoing an endothermic catalytic reforming reaction.

At the reactor outlet, the cooled gas is sent via line 7 to a second combustion chamber 8 where it is reheated by combustion of fuel gas supplied via line 9. At the outlet from the combustion chamber, the hot gas is sent at a temperature of close to 750° C. to a turbo-expander 10 which drives an alternator 1 to produce electricity.

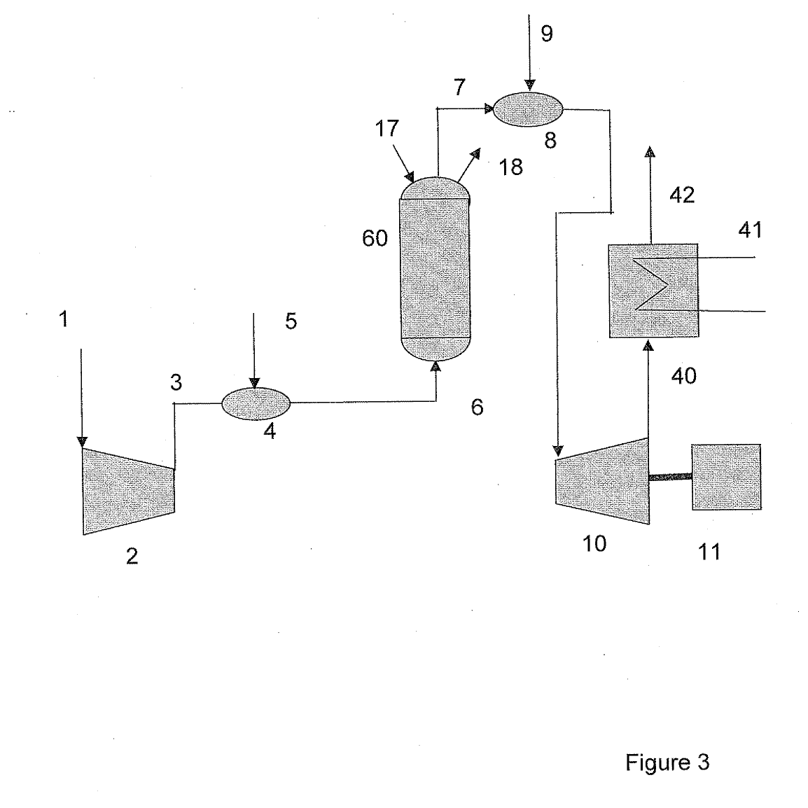

FIG. 3 describes a variation of FIG. 1 in which heat is recovered from hot gases moving via a line 40 at the outlet from the turbine 10. The exchanger 41 can recover heat either:
by producing steam which may be used in the refinery or to produce electricity;
or by heating a heat transfer fluid (hot oil) which may, for example, be used to reboil the columns of the process.

The effluent gasoline from the exchanger 41 moves via a line 42.

Clearly, this variation is also possible in the same manner in the case of FIG. 2 (not shown).

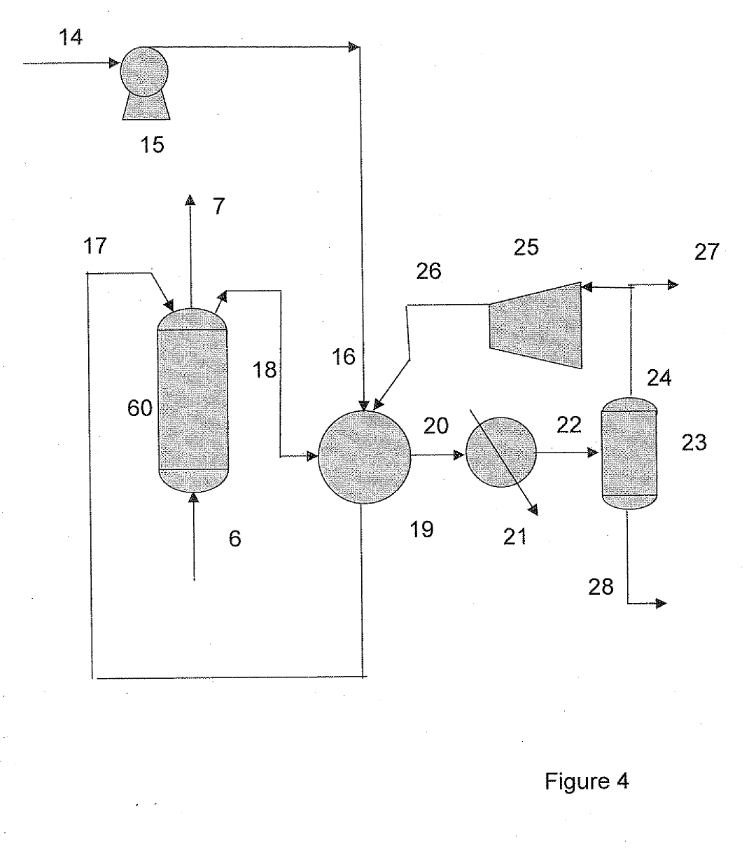

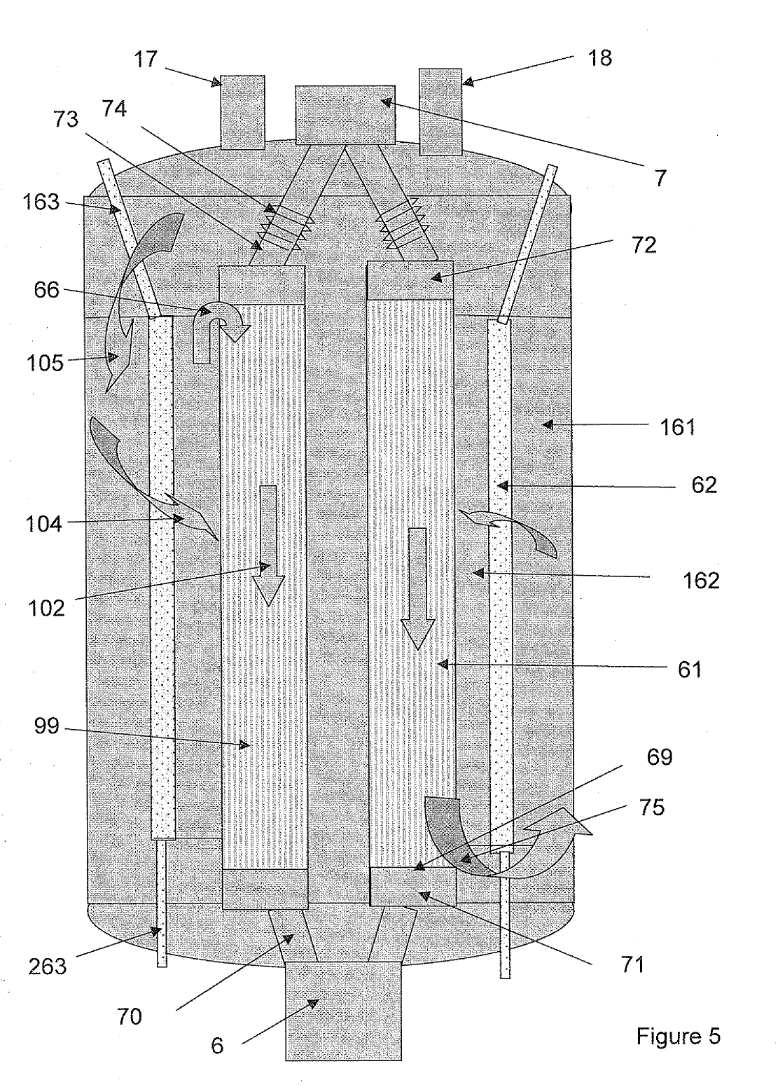

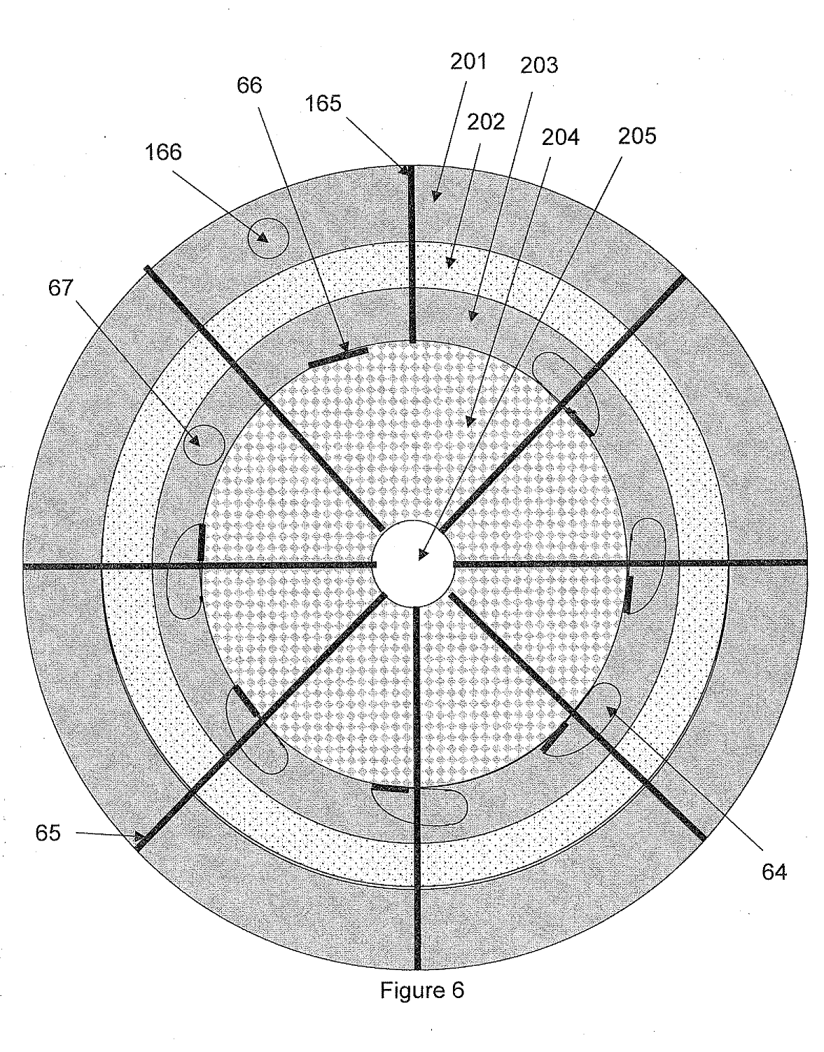

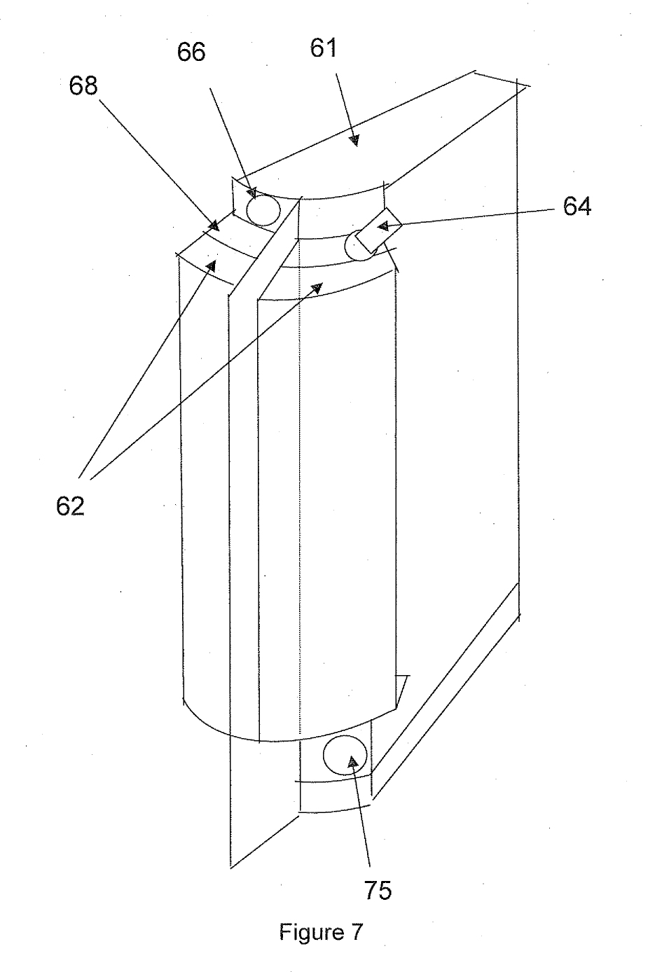

FIG. 4 shows the reaction section of a catalytic reforming section in accordance with the invention.

The combustion gas enters via line 6 and leaves the reactor 60 via line 7.

The feed arrives at a feed pump 15 via a line 14. The feed is sent from the pump outlet via a line 16 to the heat exchanger 19 which is preferably of the Packinox type.

The recycle gas which moves via a line 26 is also sent to said exchanger 19 for mixing with the feed moving via the line 16 in the exchanger and heated to a temperature close to 440° C. by exchange with the reaction mixture leaving the reactor 60 via line 18. At the outlet from the heat exchanger 19, the reaction mixture is sent to the reactor 60 via line 17. The reaction mixture leaving the reactor via line 18 is at about 490° C. and is sent to the top of the heat exchanger 19 where it is cooled to about 100° C. At the outlet from the heat exchanger 19, the effluent is sent via the line 20 to a heat exchanger 21, where it is cooled by heat exchange with air or cooling water. At the outlet from the exchanger 21, the cooled and partially condensed effluent is sent via a line 22 to a separator tank 23. The liquid from the tank is withdrawn via a line 28 to a stabilization section. Part of the gas phase from the separator tank 24, principally constituted by hydrogen, is used to constitute a gas recycle, compressed by compressor 25 then moving via line 26, the remainder being sent to a purification section via a line 27.

FIG. 5 diagrammatically shows the reactor 60 in cross sectional side view.

Four annular zones centred about the vertical axis are in succession from the edge towards the centre of the reactor, namely a first zone (visible in FIG. 6, reference numeral 201) termed the supply zone, a second zone (visible in FIG. 6 as reference numeral 202) termed the catalytic zone, a third zone (visible in FIG. 6 as reference numeral 203) termed the collection zone and a fourth zone (visible in FIG. 6 as reference numeral 204) termed the exchange zone.

Vertical hermetic panels (visible in FIG. 6 as reference numeral 65) are fixed on the cylindrical central zone (visible in FIG. 6 as reference numeral 205) and divide the reactor, preferably into 3, 4, 6 or 8 sectors.

Each sector comprises an exchange section 61 and a catalytic section 62. The ensemble of exchange sections forms the exchange zone 204 and the ensemble of catalytic sections forms the catalytic zone 202. Each sector comprises a supply section 161 and a collection section 162. The ensemble of supply sections forms the supply zone 201 and the ensemble of collection sections forms the collection zone 203.

The combustion gas moves from bottom to top in the reactor. Combustion gas is supplied via the bottom of the reactor via the inlet conduit 6 then is distributed into each exchange section via conduits 70 then via tubular chambers 71 before being distributed via tubular plates 69 into tubes 99. At the outlet from the tubes, the combustion gas is collected from the top of the reactor in tubular chambers 72 then sent via conduits 73 provided with expansion bellows 74 to the outlet conduit 7.

The reaction mixture passes through all the sectors in succession. The reaction mixture enters via the conduit 17 and at the collection section of the last sector, it is collected via the conduit (visible in FIG. 6 as reference numeral 67) then leaves the reactor via the conduit 18.

The movement of the reaction mixture, comprising hydrogen and hydrocarbons, is represented by the arrows.

The pressure at the reactor inlet is approximately 4 bars.

The reaction mixture is supplied directly to the catalytic section of the first sector (see arrow 105) then is sent via the inlet 66 (see arrow 106) to the two connected exchange sections corresponding to two sectors. The reaction mixture re-heats on dropping (arrow 102) as a counter-current to the combustion gas before being sent to the catalytic section of the second sector. The reaction mixture is then evacuated from the second sector from the top of the reactor and sent to the third sector via a conduit (visible in FIG. 6, reference numeral 64). The reaction mixture is heated up again in the exchange section of the third sector, then cooled by reacting in the catalytic section of the third sector.

As the reactions progress, fewer and fewer naphthenes remain, the paraffins are slower to react and exothermic cracking partially compensates for the endothermic nature of the other reactions. The outlet then inlet temperature profile of the reaction mixture in the successive sectors is thus ascending, which is considered to be favourable to yields.

At the outlet from the last sector, the reaction mixture is collected by the conduit (visible in FIG. 6, reference numeral 67) then sent to the outlet conduit 18.

At least one pipe 163 per sector passes through the upper head of the reactor to supply the catalytic sections with catalyst and at least one pipe 263 per sector passes through the lower bottom of the reactor to evacuate catalyst from the catalytic sections.

FIG. 6 shows the reactor viewed from the top and in section.

Four annular zones centred on the vertical axis are in succession from the edge to the centre of the reactor: the supply zone 201, the catalytic zone 202, the collection zone 203 and the exchange zone 204.

Vertical hermetic panels 65 are fixed on the central cylindrical zone 205 and a hermetic half panel 165 divides the reactor into 8 sectors.

The conduits 64 allow passage from one sector to another. The reaction mixture enters the first catalytic section via the conduit 166 into the two connected exchange sections via the inlet 66. At the outlet from the last sector, the reaction mixture is collected via the conduit 67.

FIG. 7 represents the two first sectors viewed from the shell with the two connected exchange sections 61 in the background, two catalytic sections 62 in the foreground, the outlet 75 from the two connected exchange sections, the passage 64 from the second to the third sector, a closing plate 68 and the inlet for the two linked exchange sections 66.

### Example

### With 6 Sectors Instead of 8 Sectors as Shown in FIG. 6

Consider a catalytic reforming unit processing 100 tonnes per hour of feed with 50 tonnes of catalyst.

The feed was a 80-180° C. cut with a paraffins content of 70% by volume, a naphthenes content of 20% by volume and an aromatics content of 10% by volume. The pure hydrogen/feed molar ratio was 2.

The target octane number was 100.

The whole catalyst was regenerated continuously in 3 days.

To provide the heat for the reaction, approximately 104.5 million kJ/h (approximately 25 million kcal/h), 460 tonnes of air was compressed to 4 bars absolute. The centrifugal air compressor had a polytropic efficiency of 80% and consumed 23.2 MW. The temperature at the compressor outlet was 192° C. In the first combustion chamber, 5560 kg/h of natural gas at 15° C. was burned with a lower calorific power of 46439.8 kJ/kg (11110 kcal/kg). The temperature at the combustion chamber outlet was 680° C. The combustion gas arrived via the conduit 6 at approximately 680° C.

The inlet and catalytic reforming side outlet temperatures in the various sectors were as follows (6 sectors in this example):

### Reaction Mixture

Catalytic section 1: direct entry into catalyst at 440° C., exited at 367° C.;
Catalytic section 2: entered catalyst at 490° C., exited at 428° C.;
Catalytic section 3: entered at 479° C., exited at 442° C.;
Catalytic section 4: entered at 490° C., exited at 456° C.;
Catalytic section 5: entered at 501° C., exited at 470° C.;
Catalytic section 6: entered at 512° C., exited at 485° C. (at 4.3 bars absolute).

### Combustion Gas

First and second exchange sections: entered at 680° C., exited at 410° C.;
Third exchange section: entered at 680° C., exited at 452° C.;
Fourth exchange section: entered at 680° C., exited at 464° C.;
Fifth exchange section: entered at 680° C., exited at 477° C.;
Sixth exchange section: entered at 680° C., exited at 490° C.

The combustion gas left the reactor at 450° C. after having given up 122892 million KJ/h (29.4 mM Kcal/h) to the reaction mixture.

The effluent combustion gas was sent to a second combustion chamber where 3800 kg/h of fuel gas was burned in order to reach 760° C. at a pressure of 3.4 bars absolute at the inlet to an expansion turbine. This turbine had a polytropic efficiency of 85% and provided approximately 36.2 MW of electrical power which could drive the air compressor and supply sufficient electricity for the catalytic reforming and pre-treatment units.

At the turbine outlet, the gaseous effluent was at a temperature of 526° C. which meant that either more electricity could be produced by generating steam, or a heat transfer fluid could be re-heated, which could reboil the columns of the process (the stripping column for pre treatment and stabilization of reforming).

In this example, 66.88 million Id/h (16 mM kcal/h) was available between 526° C. and 400° C., which was more than sufficient for the two columns.

The mean LMTD calculated for the reactor was 88° C., so an exchange surface of approximately 7000 m² was necessary, i.e. 6 times 1170 m². This corresponded to 6 times 827 tubes 30 mm in diameter and 15 m long.

The example is given for tubular exchangers to simplify the calculations, but the scope of the invention also encompasses using other types of exchanger, for example Packinox type welded plate exchangers.

The tubes were installed in a triangular pattern with a pitch P=38 mm. at this pitch, a cross section of 0.00125 m² (0.866×P²) was required to house one tube, and thus approximately 6.2 m² to house the 4960 tubes.

By leaving an access of 0.8 m diameter at the centre and increasing the surface area by 15% to take the sectioning into account, then a surface area of 0.5+6.2×1.15=7.63 m² was required for the whole exchange zone, i.e. a diameter of 3.1 m.

The catalyst was installed in an annular zone with an internal diameter of 3.9 m and over a height of close to 14.5 m. By assuming an weight HSV of 2, we have 50 tonnes of catalyst, i.e. about 71 m³, and thus 4.9 m² of catalytic zone (71/14.5). The external diameter of the annular catalytic zone was thus 4.6 m.

Thus, each sector comprised, starting from the outer shell:
an empty section (approximately 60 cm);
a section filled with catalyst between two Johnson screens or the equivalent thereof (approximately 70 cm);
a free section (approximately 40 cm);
an exchange section (approximately 115 cm) filled with vertical tubes 30 mm in diameter;
a central free section (radius approximately 40 cm).

In order to install the exchange tubes and the catalyst as explained above, then, a shell 6.5 m in internal diameter and approximately 17 m high was required.

The amount of coke produced was very small in the first sector and increased from sector to sector, being highest in the last sector (8% of coke if the catalyst moved in that sector for three days). One solution is to circulate the catalyst at the same rate throughout, to mix the catalyst at the reactor outlet in order to send it to the regenerator and to regenerate it as a mixture, the mean coke content then being only approximately 4%, thus allowing safe regeneration.

However, this means that the catalyst in the first sectors is regenerated before it is necessary, so it is clearly preferable to make the dimensions of the catalyst downflow devices such that the catalyst from the first sectors drops more slowly and the catalyst from the last sectors drops more quickly.

1. A reactor for carrying out an endothermic gas phase reaction having a cylindrical shape along a vertical axis and comprising:
at least four annular zones, centred on the vertical axis and in succession from the edge towards the centre of the reactor, namely a first zone (201) termed the supply zone, a second zone (202) termed the catalytic zone, a third zone (203) termed the collection zone and a fourth zone (204) termed the exchange zone;
vertical hermetic panels (65) located along the radii of the cylindrical reactor which divide the reactor into sectors, said sectors each comprising at least one exchange section (61) and at least one catalytic section (62), the ensemble of said exchange sections forming the exchange zone (204) and the ensemble of said catalytic sections forming the catalytic zone (202);
and in which the two first exchange sections are connected and in which a conduit (64) connects the collection section of each sector, with the exception of the first and last sector, to the exchange section of the next sector.

2. A reactor according to claim 1, in which the vertical hermetic panels (65) are fixed along a central cylindrical zone (205), said sectors each comprising an exchange section (61), a catalytic section (62), a supply section (161) and a collection section (162), the ensemble of said exchange sections forming the exchange zone (204), the ensemble of said catalytic sections forming the catalytic zone (202), the ensemble of said supply sections forming the supply zone (201) and the ensemble of said collection sectors forming the collection zone (203).

3. A reactor according to claim 1, in which at least one pipe (163) per sector passes through the upper head of the reactor to supply the catalytic sections with catalyst and at least one pipe (263) per sector passes through the lower bottom of the reactor to evacuate catalyst from the catalytic sections.

4. A reactor according to claim 1, comprising an upper head and a lower bottom and in which:
a supply conduit (17) passing through the upper head of the reactor can supply a sector, denoted the first sector, with reaction mixture;
an evacuation conduit (18) passing through the upper head of the reactor can evacuate reaction mixture from the last sector of the reactor;
a conduit (67) connects the collection zone of the last sector to the conduit (18) in order to evacuate the reaction mixture.

5. A reactor according to claim 1, in which:
an inlet conduit (6) passing through the lower bottom of the reactor is connected to conduits (70) leading to tubular chambers (71), said tubular chambers distributing combustion gas by means of tubular plates (69) via the bottom of the reactor and into each exchange section;
tubular chambers (72) can collect combustion gas from the top of each exchange section, then conduits (73) provided with expansion bellows (74) can evacuate the combustion gas to the outlet conduit (7) which passes through the upper head of the reactor.

6. A reactor according to claim 1, in which each catalytic section is formed by two concentric metal screens.

7. A reactor according to claim 1, in which each exchange section is constituted by tubular exchangers.

8. A reactor according to claim 1, in which each exchange section is constituted by plate exchangers.

9. A reactor according to claim 1, in which each exchange section has an identical surface area.

10. A reactor according to claim 1, in which the exchange surface area increases from the first to the last exchange section.

11. A reactor according to claim 1, in which all of the catalytic sections have the same dimensions.

12. A reactor according to claim 1, in which the dimensions of the catalytic sections increase from the first to the last catalytic section.

13. A reactor according to claim 1, in which the vertical hermetic panels (65) divide the reactor into 3, 4, 6 or 8 sectors.

14. A process for carrying out a catalytic reforming reaction or a hydrocarbon dehydrogenation reaction in a reactor in accordance with claim 1.

15. A process according to claim 14, in which the reaction mixture enters the reactor via the conduit (17) then moves into the supply zone of the first sector, passes radially through the catalytic section (62), passing from the supply zone (201) to the collection zone (203) of the reactor, moves into the collection section of the first sector before moving from top to bottom in the two connected exchange sections corresponding to the two first sectors, passes under the second catalytic section (62) between the catalyst down pipes (263), then passes radially through the second catalytic section (62), passing from the first zone (201) to the third zone (203) of the reactor, passes to the exchange section of the third sector via the conduit (64), then moves in succession and in alternating manner in the next exchange sections and the next catalytic sections.

16. A process according to claim 14, in which the catalyst moves from top to bottom at the same rate in all of the catalytic sections.

17. A process according to claim 14, in which the catalyst moves from top to bottom at a rate which increases from the first to the last catalytic section.

18. A process according to claim 14, in which the pressurized combustion gas heats the reaction mixture by an indirect heat exchange.

19. A process according to claim 18, in which the combustion gas supplying the reactor (60) via the conduit (6) derives from heating air at atmospheric pressure moving via a line (1) to an air compressor (2) then via a line (3) towards a combustion chamber (4) in which burning a fuel gas moving via a line (5) can heat the combustion gas to a temperature in the range 600° C. to 800° C.

20. A process according to claim 18, in which the combustion gas supplying the reactor (60) via the conduit (6) derives from heating air at atmospheric pressure moving via a line (1) to an air compressor (2) then via a line (3) towards a combustion chamber (4) in which burning of a fuel gas moving via a line (5) can heat the combustion air which then passes via an expansion turbine (12) which is on the same shaft as the air compressor and which provides the power necessary for compression, the combustion gas leaving the expansion turbine (12) being at a pressure in the range 0.2 to 0.45 MPa, and at a temperature in the range 600° C. to 800° C.

21. A process according to claim 19, in which the combustion gas leaving the reactor via the conduit (7) is re-heated in a combustion chamber (8) before being sent to a turbo-expander (10) to produce electricity.
